(19) United States
(12) Patent Application Publication
(10) Pub. No.: US 2006/0119584 A1
(43) Pub. Date: Jun. 8, 2006

(54) Electronic whiteboard and its operation method

(76) Inventors: Chang-Chin Lai, Taipei (TW); Vam Chang, Taipei (TW)

Correspondence Address: HARNESS, DICKEY & PIERCE, P.L.C., P.O. BOX 8910, RESTON, VA, 20195, US

(21) Appl. No.: 11/001,184

(22) Filed: Dec. 2, 2004

(51) Int. Cl. G09G 5/00

(52) U.S. Cl. 345/173

(57) ABSTRACT

An electronic whiteboard with the network function is disclosed. The whiteboard contains a network module and a memory module. The memory module includes a memory card to receive and record in the memory card the contents written on the electronic whiteboard. It is convenient for the user to store, carry, and share the data. The network module is connected to a network through a wired or wireless interface. It further transmits data written on the whiteboard or stored in the memory card to a printer via the network for printing.

### BACKGROUND OF THE INVENTION

1. Field of Invention

The invention relates to an electronic whiteboard and, in particular, to a whiteboard with storage and network functions. The contents written on the whiteboard are stored to a memory card, and data can be transmitted to a printer for printing.

2. Related Art

For a normal optical whiteboard, the user uses a whiteboard marker to write on a scrollable board. When printing, the board is scrolled toward one direction. A large optical scanner installed on one side scans contents written on the board. The data are stored in a control board for printing. However, the scrollable device and the large optical scanner are very expensive. Therefore, it is very hard for people to appreciate. Moreover, the conventional optical whiteboards cannot be connected to computers. Thus, the data cannot be stored easily.

The prior art also discloses an electronic whiteboard with infrared (IR) and ultrasonic techniques. It is implemented in the following way. An ordinary blackboard is installed with two receivers and a controller. When an IR pen is put on the blackboard, the two receivers detect and compute the relative distances in order to determine its position. However, the IR light may be shielded and the IR pen is fragile. Such a design thus has the problem of a high disorder rate. A simple electromagnetic (EM) inductive electronic whiteboard has also been disclosed. Although it has a higher reliability and resolution, the EM interference allows the use of only one EM inductive pen, thereby forbidding multiple users to access at the same time.

### SUMMARY OF THE INVENTION

In view of the foregoing, an objective of the invention is to provide an electronic whiteboard that has the function of access a printer for printing via a network. The electronic whiteboard includes a detecting board, an inductive pen, an analog/digital (A/D) converter, a memory module, and a network module. The detecting board is connected to the A/D converter via wires. The track of the inductive pen on the detecting board produces a signal of the corresponding coordinates. The coordinate signals are transmitted to the A/D converter to be turned into image data. When printing the contents written thereon, the electronic whiteboard is connected to a network in a wired or wireless means. The image data from the A/D converter are then sent via the network to the printer for printing.

The memory module can receive the image data from the A/D converter and store them in a memory card. Another objective of the invention is thus to store contents written on the electronic whiteboard so that its user can store, keep, and exchange data. The memory module contains a receiving unit to receive the image data of the contents written on the electronic whiteboard, a memory card to record the received image data, and a card-reading unit to read the image data stored on the memory card.

The electronic whiteboard includes a detecting board, an inductive pen, an A/D converter, a memory module, and a network module. The operation method of the electronic whiteboard includes the steps of: generating a coordinate signal for the track of the inductive pen on the detecting board; converting the coordinate signal into image data using an analog/digital (A/D) converter; receiving the image data from the A/D converter and storing them in the memory module (e.g. storing the image data in a memory card); connecting to a network via the network module to print the image data to a printer on the network. The network can be a wired or wireless network.

### BRIEF DESCRIPTION OF THE DRAWINGS

The invention will become more fully understood from the detailed description given hereinbelow illustration only, and thus are not limitative of the present invention, and wherein:

FIG. 1 is a block diagram of the disclosed electronic whiteboard;

FIG. 2 is a block diagram of the memory module in the disclosed electronic whiteboard;

FIG. 3 is a block diagram of the network module in the disclosed electronic whiteboard; and

FIG. 4 is a flowchart of the operation method of the disclosed electronic whiteboard.

### DETAILED DESCRIPTION OF THE INVENTION

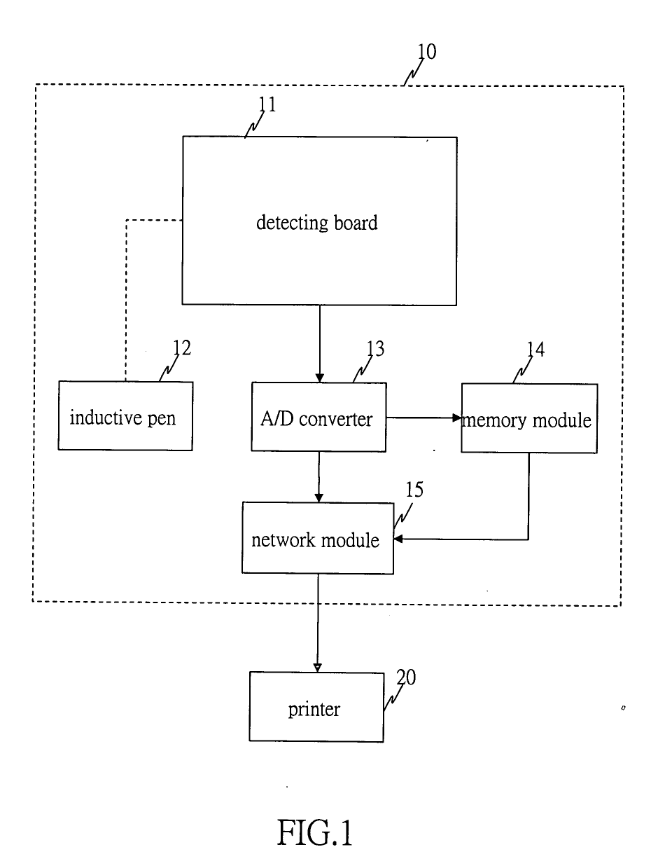

The disclosed electronic whiteboard can connect to a network and send contents written thereon to a printer for printing. As shown in FIG. 1, the electronic whiteboard 10 has a detecting board 11, an inductive pen 12, an analog/digital (A/D) converter 13, a memory module 14, and a network module 15. The user uses the inductive pen 12 to touch upon or get close to the detecting board 11, thereby writing on the whiteboard. The detecting board 11 generates a corresponding signal of the coordinates. The coordinate signal is then sent to the A/D converter 13 to be converted into image data. The image data are sent to the memory module 14. Therefore, one can readily store contents written on the electronic whiteboard in a memory card of the memory module 14. The electronic whiteboard 10 uses the network module 15 to receive the image data sent from the A/D converter 13 or stored in the memory module 14. The image data can be sent to a printer 20 for printing via the network. The network module 15 referred herein can be either a wired network module or a wireless network module connected to a wired or wireless network, respectively.

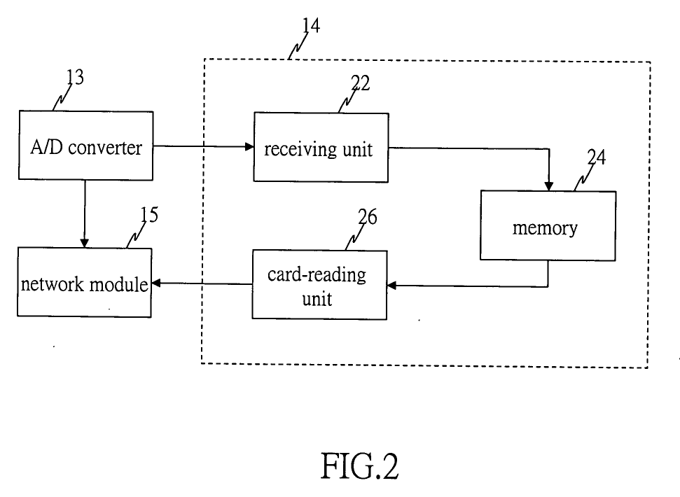

The memory module of the disclosed electronic whiteboard as depicted in FIG. 2 is used to store contents written thereon by the user. It contains a receiving unit 22, a memory card 24, and a card-reading unit 26. The receiving unit 22 receives the image data from the A/D converter 13 and stores the received data in the memory 24. Therefore, the user can store or exchange data. The card-reading unit 26 can read out the image data stored in the memory card 24 and send them to the electronic whiteboard, recovering the recorded image data.

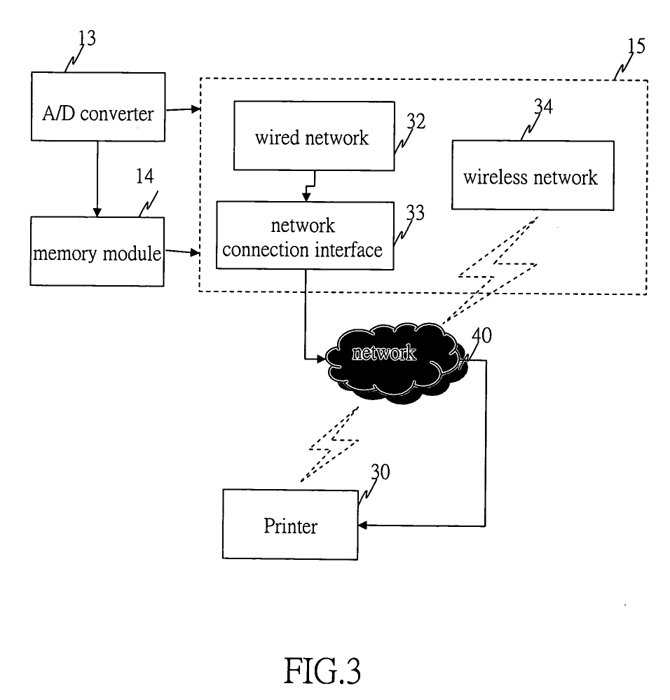

As shown in FIG. 3, the network module 15 can be either a wired network 32 or a wireless network 34. The wired network module 32 contains a network connection interface 33 for connecting the electronic whiteboard to the wired network via a network cable. If the network module 15 is a wireless network module 34, then the electronic whiteboard 10 is connected to the wireless network using the wireless transmission technology. Therefore, when the electronic whiteboard 10 is connected to the network 40, a printer 30 on the network 40 can be assigned for printing contents on the electronic whiteboard 10. The disclosed network module 15 is connected to the A/D converter 13 or the memory module 14 for receiving the image data sent from the A/D converter 13 or stored in the memory card 24 of the memory module 14. Aside from sending image data via the network 40 to the printer 20 for printing, the disclosed network module 15 can further exchange data via the network 40. The user can thus send image data to a computer host on the network 40 for long-term storage.

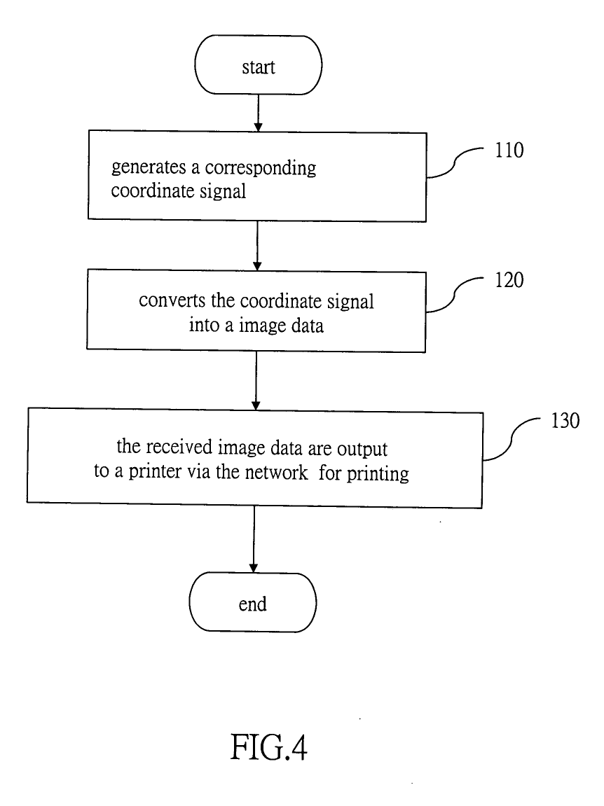

The flowchart of the disclosed operation method for the electronic whiteboard is shown in FIG. 4. The electronic whiteboard contains a detecting board, an inductive pen, an A/D converter, a memory module, and a network module. The operation method is as follows. First, the track of the inductive pen on the detecting board generates a corresponding coordinate signal (step 110). The detecting board is connected to the A/D converter via wires, transmitting the coordinate signal to the A/D converter. The A/D converter then converts the coordinate signal into an image data (step 120). The network module is a wired or wireless network module for connecting to a wired or wireless network, respectively. The network module is connected to the A/D converter to receive image data. The received image data are output to a printer via the network for printing (step 130). Moreover, the electronic whiteboard contains a memory module 14 connected to the A/D converter. Therefore, the memory module 14 also receives the image data from the A/D converter and stores the received image data to the memory module (such as a memory card). The network module can also connect to the memory module to read image data stored thereon. The image data recorded in the memory module 14 are output via the network 40 to a printer 20 for printing.

Certain variations would be apparent to those skilled in the art, which variations are considered within the spirit and scope of the claimed invention.

What is claimed is:

1. An electronic whiteboard with a detecting board, an inductive pen, and an analog/digital (A/D) converter, the detecting board being connected to the A/D converter via wires, the inductive pen inducing a coordinate signals of its position on the detecting board, and the A/D converter converting the coordinate signal into an image data, wherein the electronic whiteboard is characterized in that it further contains:
a memory module, which connects to the A/D converter to receive and store the image data; and
a network module, which receives the image data and print the image data to a printer via a network.

2. The electronic whiteboard of claim 1, wherein the memory module includes a memory card to store the image data.

3. The electronic whiteboard of claim 1, wherein the network module is connected to the memory module to receive data stored in the memory module.

4. The electronic whiteboard of claim 1, wherein the network module is connected to the A/D converter to receive the image data.

5. The electronic whiteboard of claim 1, wherein the network module is a wireless network module connected to a wireless network.

6. The electronic whiteboard of claim 1, wherein the network module contains a network interface connected to a wired network.

7. The electronic whiteboard of claim 1, wherein the printer is a network printer.

8. An operation method of an electronic whiteboard comprising the steps of:
generating a coordinate signal according to a track of an inductive pen on the electronic whiteboard;
converting the coordinate signal into an image data; and
outputting the image data to a printer via a network for printing.

9. An operation method of an electronic whiteboard as in claim 8, wherein the network is selected from the group consisting of a wired network and a wireless network.

10. An operation method of an electronic whiteboard as in claim 8, wherein the image data are stored in a memory card.
